(19) United States
(12) Patent Application Publication
(10) Pub. No.: US 2006/0227383 A1
(43) Pub. Date: Oct. 12, 2006

(54) Edge enhancement apparatus and liquid crystal display apparatus

(76) Inventor: Katsuhiko Kishida, Kawasaki-shi (JP)

Correspondence Address: HARNESS, DICKEY & PIERCE, P.L.C., P.O. BOX 8910, RESTON, VA, 20195, US

(21) Appl. No.: 11/356,243

(22) Filed: Feb. 17, 2006

(30) Foreign Application Priority Data
Mar. 23, 2005 (JP) 2005-084544

(51) Int. Cl. G06F 15/00

(52) U.S. Cl. 358/3.27; 358/1.9

(57) ABSTRACT

An edge enhancement apparatus includes an edge detecting unit coupled to a supply node supplying an image signal, to produce at an output node a first signal indicative of presence of an image edge in the image signal, a Mach checking unit coupled to the supply node to produce at an output node a second signal indicative a magnitude of a Mach effect in respect of the image edge, and an edge enhancement unit coupled to the supply node, the output node of the edge detecting unit, and the output node of the Mach checking unit, to determine a lightness change and a chroma change to be made in the image signal in response to the first signal and second signal, and to perform edge enhancement on the image signal by changing at least one of lightness and chroma in response to the determined lightness change and chroma change.

### BACKGROUND OF THE INVENTION

1. Field of the Invention

The present invention generally relates to image processing, and particularly relates to edge enhancement that enhances edges appearing in images.

2. Description of the Related Art

When images are displayed on a CRT display, edge enhancement is applied to the images so as to reduce blurring at contours and outlines appearing in the images. In conventional edge enhancement techniques, edge enhancement is performed by changing brightness.

FIG. 1 is a block diagrams showing the configuration of a related-art edge enhancement unit. The edge enhancement unit of FIG. 1 includes a color conversion unit 10, an edge detecting unit 11, an edge enhancing unit 12, and a color conversion unit 13.

The color conversion unit 10 converts input RGB into LCh. Here, L represents lightness, C representing chroma, and h representing hue. In reality, lightness, chroma, and hue are subjective quantities. As objective quantities that are correlated to these subjective quantities, therefore, metric lightness, metric chroma, and metric hue that are defined in the CIEL*a*b* color space are used.

To be specific, the conversion from RGB to LCh is performed by converting colors from the RGB color system to the XYZ color system, followed by converting colors from the XYZ color system to the CIEL*a*b* color system, and then obtaining metric lightness, metric chroma, and metric hue in the CIEL*a*b* color system. The RGB color system and the XYZ color system are related as:
R=(x_{R}/y_{R})R^{Y}YR+(x_{G}/y_{G})G^{Y}YG+(x_{B}/y_{B})B^{Y}YB
G=R^{Y}YR+G^{Y}YG+B^{Y}YB (1)
Z=(z_{R}/y_{R})R^{Y}YR+(z_{G}/y_{G})G^{Y}YG+(z_{B}/y_{B})B^{Y}YB.
Here, R^{γ}, G^{γ}, B^{γ} are RGB values that take into account the gamma characteristics of the display apparatus. YR, YG, and YB are white balance that takes into account the maximum brightness of each of the RGB primary colors. Xᵢ and yᵢ are the xy chromaticity coordinates of a primary color i, and zᵢ is defined as 1-xᵢ-yᵢ.

Further, the XYZ color system and the CIEL*a*b* color system are related as:
L*=116(Y/Yn)^{1/3}−16
a*=500[(X/Xn)^{1/3}−(Y/Yn)^{1/3}] (2)
b*=200[(Y/Yn)^{1/3}−(Z/Zn)^{1/3}].
Here, if Y/Yₙ≦0.008856, X/Xₙ≦0.008856, and Z/Zₙ≦0.008856, the following replacement is made in the above formula.
(Y/Yn)^{1/3}→7.787(Y/Yn)+16/116
(X/Xn)^{1/3}→7.787(X/Xn)+16/116
(Z/Zn)^{1/3}→7.787(Z/Zn)+16/116

In the CIEL*a*b* color system as calculated above, metric lightness is L* appearing in the above formula. Metric chroma and metric hue are represented as follows.
C*=(a*²+b*²)^{1/2} (3)
Δh*=[(Δa*)²+(Δb*)²−(Δc*)²]^{1/2} (4)

As previously described, these metric quantities are used as lightness L, chroma C, and hue h.

The edge detecting unit 11 shown in FIG. 1 detects edges by calculating a difference in lightness L between pixels. The edge detecting unit 11 supplies a signal indicative of the presence/absence of an edge at a position of interest in the image to the edge enhancing unit 12.

When the signal supplied from the edge detecting unit 11 indicates the presence of an edge, the edge enhancing unit 12 changes lightness L such as to enhance the edge. In so doing, chroma C and hue h are not modified at all.

In this manner, the edge enhancing unit 12 generates post-edge-enhancement lightness L′, chroma C, and hue h. The color conversion unit 13 converts input L′Ch into R′G′B′. This provision performs edge enhancement by only changing lightness without changing chroma or hue. The post-edge-enhancement image signals R′, G′, and B′ are supplied to a liquid crystal display panel for the presentation of the image.

When edge enhancement as described above is performed with respect to a liquid crystal display, a strong Mach effect may appear. The Mach effect is an effect by which human visual perception perceives a change at the boundary in an enhanced manner when areas having different lightness (or chroma, hue) are placed adjacent to each other. Due to this Mach effect, an area having constant lightness (or chroma, hue) may appear as if there is gradation.

Unlike CRTs, liquid crystal display panels have such characteristics that response speed is slow with respect to hold light emission. When an image showing movement is displayed, edge portions, i.e., outline portions, may thus become blurred.

[Patent Document 1] Japanese Patent Application Publication No. 2001-203911

Accordingly, there is a need for an edge enhancement apparatus and a liquid crystal display apparatus having the edge enhancement apparatus for performing edge enhancement that can suppress excessive enhancement caused by the Mach effect, and that is suitable for liquid crystal display panels.

Further, there is a need for an edge enhancement apparatus and a liquid crystal display apparatus having the edge enhancement apparatus that can improve the response speed of the liquid display panel.

### SUMMARY OF THE INVENTION

It is a general object of the present invention to provide an edge enhancement apparatus and a liquid crystal display apparatus that substantially obviate one or more problems caused by the limitations and disadvantages of the related art.

It is another and more specific object of the present invention to provide an edge enhancement apparatus and a liquid crystal display apparatus having the edge enhancement apparatus for performing edge enhancement that can suppress excessive enhancement caused by the Mach effect, and that is suitable for liquid crystal display panels.

It is yet another object of the present invention to provide an edge enhancement apparatus and a liquid crystal display apparatus having the edge enhancement apparatus that can improve the response speed of the liquid display panel.

To achieve these and other objects in accordance with the purpose of the invention, the invention provides an apparatus for enhancing an edge, which includes an edge detecting unit coupled to a supply node supplying an image signal, to produce at an output node thereof a first, signal indicative of presence of an image edge in the image signal, a Mach checking unit coupled to the supply node to produce at an output node thereof a second signal indicative a magnitude of a Mach effect in respect of the image edge, and an edge enhancement unit coupled to the supply node, the output node of the edge detecting unit, and the output node of the Mach checking unit, to determine a lightness change and a chroma change to be made in the image signal in response to the first signal and the second signal, and to output the image signal on which edge enhancement is performed by changing at least one of lightness and chroma in response to the determined lightness change and chroma change.

According to another aspect of the present invention, an apparatus for enhancing an edge includes an edge detecting unit coupled to a supply node supplying an image signal, to produce at an output node thereof a first signal indicative of presence of an image edge in the image signal, and an edge enhancement unit coupled to the supply node and the output node of the edge detecting unit to select, from a plurality of different combinations of a lightness change, a chroma change, and a hue change to be made in the image signal within a range of a predetermined color difference, a combination that achieves a fastest response speed of a device for displaying the image signal, and to output the image signal on which edge enhancement is performed by changing at least one of lightness, chroma, and hue according to the selected combination.

According to at least one embodiment of the present invention, the fact that the Mach effect strongly appears in response to a lightness change is taken into consideration, and edge enhancement mainly based on a chroma change, rather than edge enhancement based on a lightness change, is performed in order to suppress excessive enhancement caused by the Mach effect. With this provision, proper edge enhancement is achieved while avoiding excessive enhancement caused by the Mach effect.

Further, according to at least one embodiment of the present invention, a plurality of different combinations of a lightness change, a chroma change, and a hue change of the image signal is prepared, and the combination that achieves the fastest response speed of the device for displaying the image signal is selected. The edge enhancement is then performed by changing at least one of lightness, chroma, and hue. With this provision, the response speed can be improved while performing necessary edge enhancement.

### BRIEF DESCRIPTION OF THE DRAWINGS

FIG. 1 is a block diagrams showing the configuration of a related-art edge enhancement unit;

FIG. 2 is a block diagram showing the configuration of a first embodiment of an edge enhancement circuit according to the present invention;

FIG. 3 is a block diagram showing the configuration of a second embodiment of the edge enhancement circuit according to the present invention;

FIG. 4 is a block diagram showing the configuration of a third embodiment of the edge enhancement circuit according to the present invention; and

FIG. 5 is a table chart showing the test results of edge enhancement according to the third embodiment.

### DESCRIPTION OF THE PREFERRED EMBODIMENTS

In the following, the principle and embodiments of the present invention will be described with reference to the accompanying drawings.

The Mach effect occurs in response to any one of lightness contrast, chroma contrast, and hue contrast. The strengths of the respective effects differ, and are arranged in the following order: lightness contrast>chroma contrast>hue contrast. In this manner, the Mach effect takes place with strong magnitude in response to a lightness change. In order to suppress excessive enhancement caused by the Mach effect, it is thus effective to perform edge enhancement mainly based on chroma changes rather than edge enhancement based on lightness changes.

When chroma-based edge enhancement is to be designed, it is preferable to perform edge enhancement by taking into account the Liebman effect. The Liebman effect refers to the fact that how easy it is to discriminate a figure from a background color depends on the color coordination, and that visibility is highest when yellow and black are used, for example. Chroma C is thus changed by taking into account the Liebman effect such that a color difference stays within a predetermined range.

The calculation of a color difference may be done by using the CIE1994 color difference formula as follows.
ΔE=[(Δh*/(1+0.015c*))²+(ΔL*)²+(Δc*/(1+0.045c*))²]^{1/2} (5)
Here, ΔL*, Δh*, Δc* are a difference in the respective psychological metric quantities.

To be specific, chroma C is changed within such a range that ΔE stays smaller than or equal to 2.0, thereby performing edge enhancement, for example. Namely, a chroma difference is created in a proper amount such that ΔE stays smaller than or equal to 2.0, thereby reducing the blurring of contours (outlines) appearing in images.

In so doing, edge enhancement based on lightness changes as in the conventional method may be performed with respect to image portions where the Mach effect does not appear strongly. Namely, a ratio of a lightness change to a chroma change is controlled as appropriate in response to the strength of the Mach effect that is dependent on position in the image.

Further, as previously described, liquid crystal display panels have a problem in that edge portions, i.e., outline portions, are blurred in images showing movement because of the slow response speed of the display panel with respect to hold light emission. In the present invention, when edge enhancement is performed, a plurality of different combinations of lightness difference ΔL, chroma difference ΔC, and hue difference Δh are prepared that achieve a predetermined color difference ΔE, and the combination that achieves the fastest response speed is selected from the plurality of combinations. The selected lightness difference ΔL, chroma difference ΔC, and hue difference Δh are then used to perform edge enhancement.

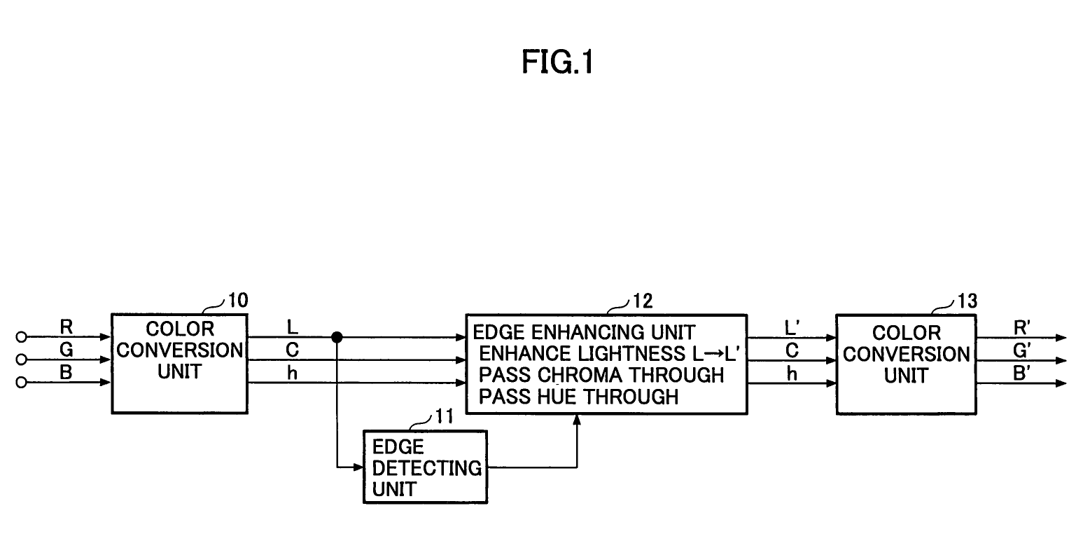

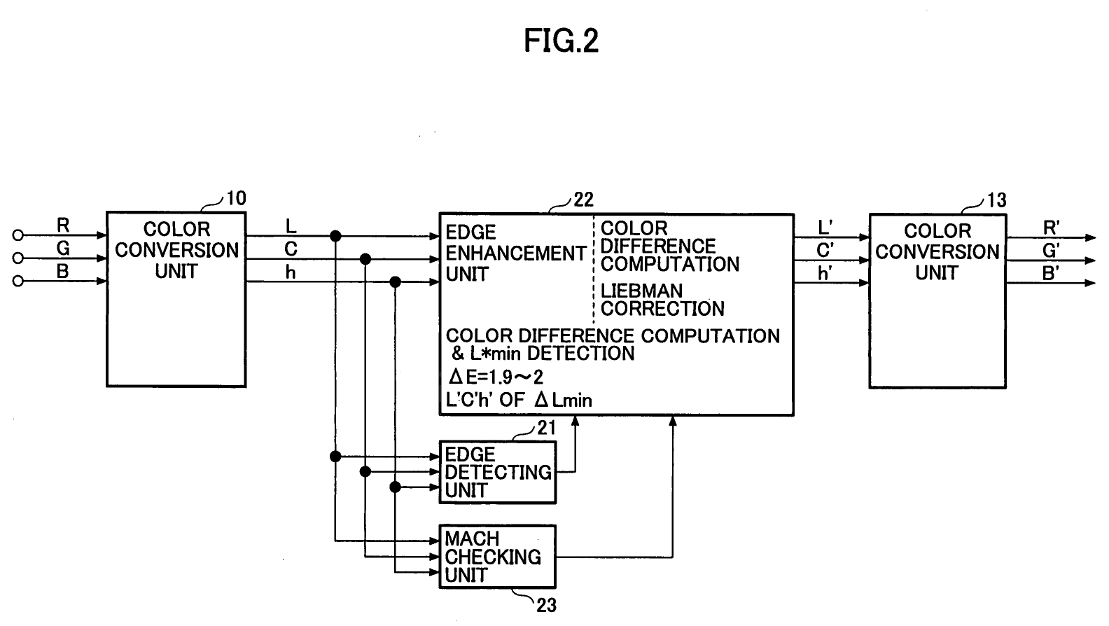

FIG. 2 is a block diagram showing the configuration of a first embodiment of an edge enhancement circuit according to the present invention. In FIG. 2, the same elements as those of FIG. 1 are referred to by the same numerals, and a description thereof will be omitted.

The edge enhancement unit of FIG. 2 includes the color conversion unit 10, an edge detecting unit 21, an edge enhancement unit 22, a Mach checking unit 23, and the color conversion unit 13.

The edge detecting unit 21 detects an edge by calculating differences in lightness L, chroma C, and hue h between pixels. The edge detecting unit 21 supplies a signal indicative of the presence/absence of an edge at a position of interest in the image to the edge enhancement unit 22.

The Mach checking unit 23 checks the strength of the Mach effect (the magnitude of the Mach effect that would be generated by the edge enhancement) based on the lightness L, chroma C, and hue h between the pixels. The Mach checking unit 23 supplies to the edge enhancement unit 22 a signal indicative of the strength of the Mach effect at the position of interest in the image, i.e., a signal indicative of the check result of the Mach check

When the signal supplied from the edge detecting unit 21 indicates the presence of an edge, the edge enhancement unit 22 changes at least one of lightness L, chroma C, and hue h so as to perform a process that enhances the edge. If the check result signal supplied from the Mach checking unit 23 indicates the presence of a strong Mach effect, a Liebman correction is performed with respect to the normal edge enhancement that is based on a lightness-L change. To be specific, a switch from edge enhancement based on a lightness change to edge enhancement based on a chroma change is made while securing a predetermined color difference.

In the edge enhancement unit 22, changes in lightness L, chroma C, and hue h required for edge enhancement may be computed based on the result of the Mach check by use of a CPU performing a computation program. Alternatively, provision may be made such that appropriate changes in lightness L, chroma C, and hue h associated with individual Mach check results may be stored in a lookup table, which is referred to in response to a check result supplied from the Mach checking unit 23, thereby determining changes in lightness L, chroma C, and hue h used for edge enhancement.

The Mach check and Liebman correction are well-known in the art, and a description thereof will be omitted. Further, a specific method of determining changes in lightness L, chroma C, and hue h is not limited to a particular algorithm.

In this manner, the edge enhancement unit 22 generates post-edge-enhancement lightness L′, chroma C′, and hue h′. Such lightness L′, chroma C′, and hue h′ are supplied to the color conversion unit 13 for conversion into R′, G′, and B′. The post-edge-enhancement image signals R′, G′, and B′ are supplied to a liquid crystal display panel for the display of the image. With this provision, proper edge enhancement is performed while avoiding excessive enhancement caused by the Mach effect.

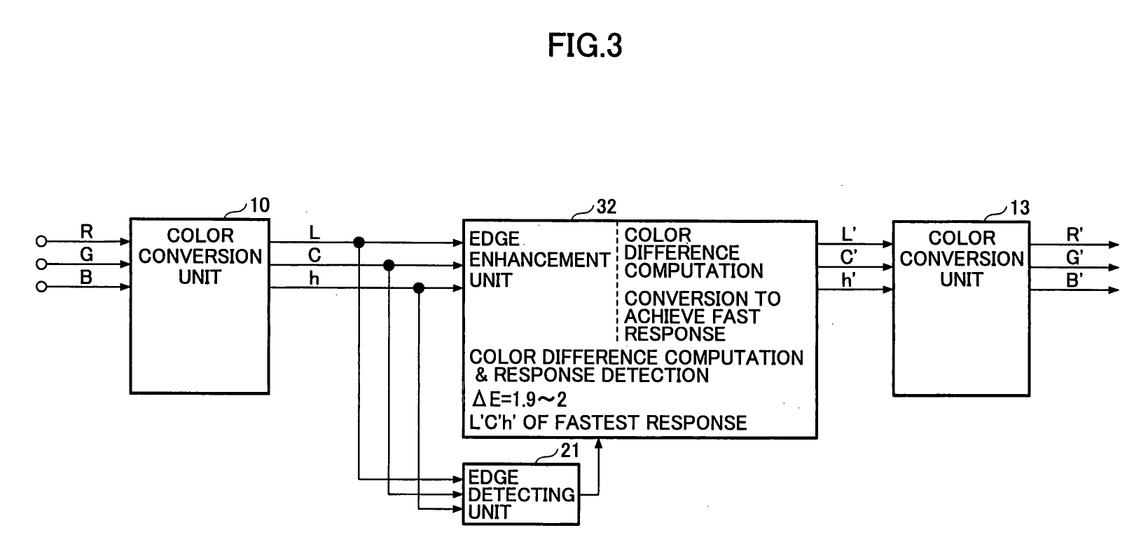

FIG. 3 is a block diagram showing the configuration of a second embodiment of the edge enhancement circuit according to the present invention. In FIG. 3, the same elements as those of FIG. 2 are referred to by the same numerals, and a description thereof will be omitted.

The edge enhancement unit of FIG. 3 includes the color conversion unit 10, the edge detecting unit 21, an edge enhancement unit 32, and the color conversion unit 13.

The edge detecting unit 21 detects an edge by calculating differences in lightness L, chroma C, and hue h between pixels. The edge detecting unit 21 supplies a signal indicative of the presence/absence of an edge at a position of interest in the image to the edge enhancement unit 32.

When the signal supplied from the edge detecting unit 21 indicates the presence of an edge, the edge enhancement unit 32 changes at least one of lightness L, chroma C, and hue h so as to perform a process that enhances the edge. Upon determining that edge enhancement is necessary in response to the signal from the edge detecting unit 21, the edge enhancement unit 32 prepares a plurality of different combinations of lightness L, chroma C, and hue h that achieve a predetermined color difference. The edge enhancement unit 32 then selects the combination that achieves the fastest response speed from the plurality of combinations. The selected combination is output as post-edge-enhancement lightness L′, chroma C′, and hue h′.

Such lightness L′, chroma C′, and hue h′ are supplied to the color conversion unit 13 for conversion into R′, G′, and B′. The post-edge-enhancement image signals R′, G′, and B′ are supplied to a liquid crystal display panel for the display of the image. With this provision, response speed is increased while performing necessary edge enhancement.

The estimation of response speed with respect to each combination of lightness L, chroma C, and hue h is a well-known technology, and a description thereof will be omitted.

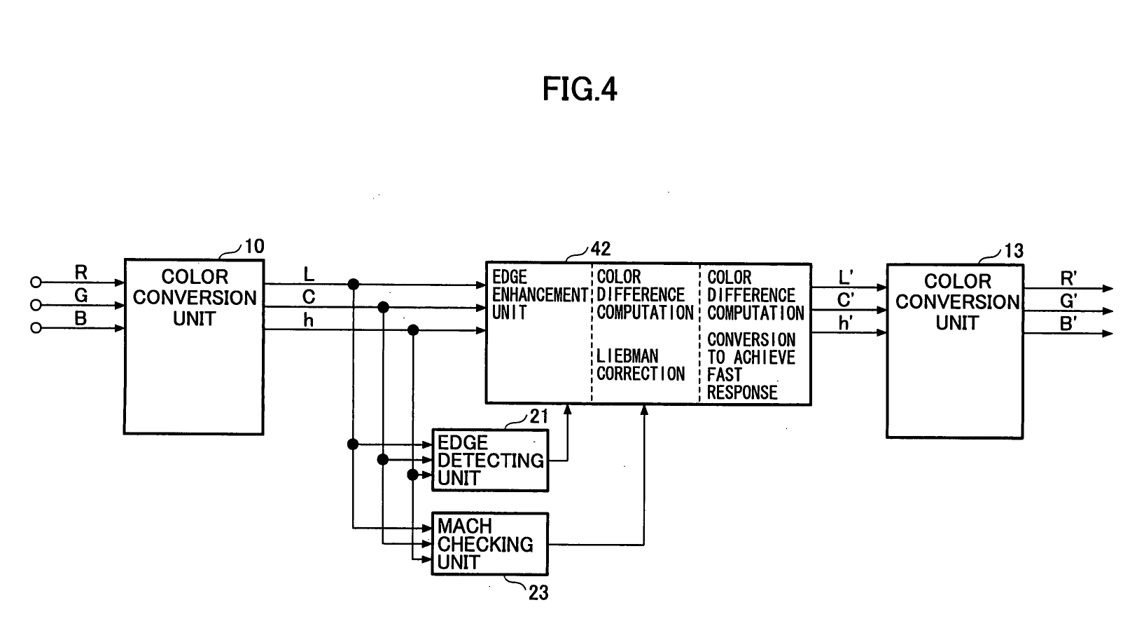

FIG. 4 is a block diagram showing the configuration of a third embodiment of the edge enhancement circuit according to the present invention. In FIG. 4, the same elements as those of FIG. 2 are referred to by the same numerals, and a description thereof will be omitted.

The edge enhancement unit of FIG. 4 includes the color conversion unit 10, the edge detecting unit 21, an edge enhancement unit 42, the Mach checking unit 23, and the color conversion unit 13. The edge enhancement unit 42 according to the third embodiment shown in FIG. 4 has both the function of the edge enhancement unit 22 of the first embodiment and the function of the edge enhancement unit 32 of the second embodiment.

In the same manner as in the first embodiment and the second embodiment, the edge detecting unit 21 detects an edge by calculating differences in lightness L, chroma C, and hue h between pixels. The edge detecting unit 21 supplies a signal indicative of the presence/absence of an edge at a position of interest in the image to the edge enhancement unit 42.

In the same manner as in the first embodiment, the Mach checking unit 23 checks the strength of the Mach effect (the magnitude of the Mach effect that would be generated by the edge enhancement) based on the lightness L, chroma C, and hue h between the pixels. The Mach checking unit 23 supplies to the edge enhancement unit 42 a signal indicative of the strength of the Mach effect at the position of interest in the image, i.e., a signal indicative of the check result of the Mach check

When the signal supplied from the edge detecting unit 21 indicates the presence of an edge, the edge enhancement unit 42 changes at least one of lightness L, chroma C, and hue h so as to perform a process that enhances the edge. If the check result signal supplied from the Mach checking unit 23 indicates the presence of a strong Mach effect, a Liebman correction is performed with respect to the normal edge enhancement that is based on a lightness-L change. To be specific, a switch from edge enhancement based on a lightness change to edge enhancement based on a chroma change is made while securing a predetermined color difference. In so doing, a plurality of different combinations of lightness L, chroma C, and hue h that achieve a predetermined color difference is obtained. The edge enhancement unit 42 then selects the combination that achieves the fastest response speed from the plurality of combinations. The selected combination is output as post-edge-enhancement lightness L′, chroma C′, and hue h′.

Such lightness L′, chroma C′, and hue h′ are supplied to the color conversion unit 13 for conversion into R′, G′, and B′. The post-edge-enhancement image signals R′, G′, and B′ are supplied to a liquid crystal display panel for the display of the image. With this provision, proper edge enhancement is performed while avoiding excessive enhancement caused by the Mach effect, and the response speed of the liquid crystal display panel is improved.

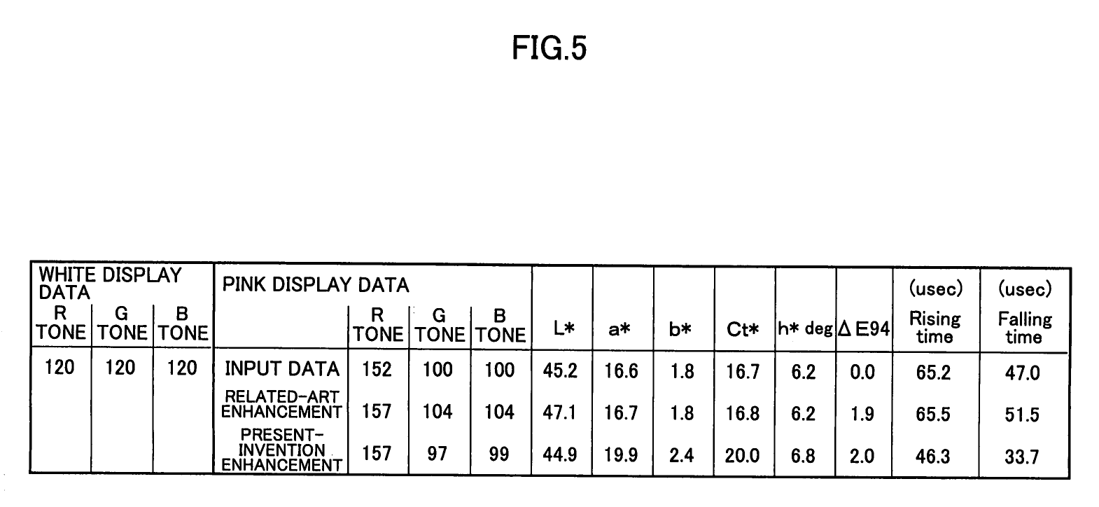

FIG. 5 is a table chart showing the test results of edge enhancement according to the third embodiment. Video images of beef are used in this test, and show a fat portion and a lean meat portion side by side. The white display data shown in the leftmost column of the table in FIG. 5 indicate RGB display data corresponding to the fat portion. The pink display data shown alongside indicate RGB display data corresponding to the lean meat portion. The related-art edge enhancement as shown in FIG. 1 is applied to the pink display data portion, and the edge enhancement according to the third embodiment of the present invention shown in FIG. 4 is also applied to the same pink display data portion. The results of these edge enhancement processes are shown.

In the table shown in FIG. 5, L*, a*, and b* are data according to the CIEL*a*b* color system. Ct*, h*deg, and ΔE94 are a chroma, a hue angle, and a color difference according to the CIE1994 color difference formula, respectively. Further, the rise response time of the liquid crystal display panel in the case of the beef images involving motion is shown as a Rising_time, and the fall response time is shown as a Falling_time.

In this test, the amount of changes in lightness L, chroma C, and hue h for edge enhancement are set such that the value of ΔE94 becomes smaller than or equal to 2. In the related-art edge enhancement, lightness L* is changed from 45.2 to 47.1 to enhance the edge. In the edge enhancement according to the present invention, on the other hand, lightness L* is scarcely changed as indicated by a minute change from 45.2 to 44.9, which does not result in a strong Mach effect. In the related-art edge enhancement, chroma Ct* is scarcely changed as indicated by a minute change from 16.7 to 16.8. In the edge enhancement according to the present invention, on the other hand, chroma Ct* is changed from 16.7 to 20.0 to enhance the edge.

Attention is now focused on the response time of the liquid crystal display panel in the case of the beef images involving motion. In the case of no edge enhancement (input data), Rising_time is 65.2 microseconds, and Falling_time is 47.0 microseconds. In the case of the related-art edge enhancement, Rising_time is 65.5 microseconds, and Falling_time is 51.5 microseconds. In the case of the edge enhancement according to the present invention, Rising_time is 46.3 microseconds, and Falling_time is 33.7 microseconds. As can be seen from these figures, the response speed is improved (made faster) according to the present invention.

Further, the present invention is not limited to these embodiments, but various variations and modifications may be made without departing from the scope of the present invention.

The present application is based on Japanese priority application No. 2005-084544 filed on Mar. 23, 2005, with the Japanese Patent Office, the entire contents of which are hereby incorporated by reference.

What is claimed is:

1. An apparatus for enhancing an edge, comprising:
an edge detecting unit coupled to a supply node supplying an image signal, to produce at an output node thereof a first signal indicative of presence of an image edge in the image signal;
a Mach checking unit coupled to the supply node to produce at an output node thereof a second signal indicative a magnitude of a Mach effect in respect of the image edge; and
an edge enhancement unit coupled to the supply node, the output node of said edge detecting unit, and the output node of said Mach checking unit, to determine a lightness change and a chroma change to be made in the image signal in response to the first signal and the second signal, and to output the image signal on which edge enhancement is performed by changing at least one of lightness and chroma in response to the determined lightness change and chroma change.

2. The apparatus as claimed in claim 1, wherein said edge enhancement unit is configured to determine the lightness change and the chroma change to be made in the image signal such that a color difference falls within a predetermined range.

3. The apparatus as claimed in claim 1, wherein said edge enhancement unit is configured to select, from a plurality of different combinations of a lightness change, a chroma change, and a hue change of the image signal within a range of a predetermined color difference, a combination that achieves a fastest response speed of a device for displaying the image signal, and is configured to perform the edge enhancement according to the selected combination.

4. The apparatus as claimed in claim 1, further comprising:
a first color conversion unit configured to obtain the image signal by performing color conversion on a first image represented according to a predetermined color system and to supply the image signal to the supply node; and
a second color conversion unit coupled to an output of said edge enhancement unit to perform color conversion on the image signal on which the edge enhancement is performed, thereby to produce a second image represented according to said predetermined color system.

5. An apparatus for enhancing an edge, comprising:
an edge detecting unit coupled to a supply node supplying an image signal, to produce at an output node thereof a first signal indicative of presence of an image edge in the image signal; and
an edge enhancement unit coupled to the supply node and the output node of said edge detecting unit to select, from a plurality of different combinations of a lightness change, a chroma change, and a hue change to be made in the image signal within a range of a predetermined color difference, a combination that achieves a fastest response speed of a device for displaying the image signal, and to output the image signal on which edge enhancement is performed by changing at least one of lightness, chroma, and hue according to the selected combination.

6. A liquid crystal display apparatus, comprising:
an edge detecting unit coupled to a supply node supplying an image signal, to produce at an output node thereof a first signal indicative of presence of an image edge in the image signal;
a Mach checking unit coupled to the supply node to produce at an output node thereof a second signal indicative a magnitude of a Mach effect in respect of the image edge; and
an edge enhancement unit coupled to the supply node, the output node of said edge detecting unit, and the output node of said Mach checking unit, to determine a lightness change and a chroma change to be made in the image signal in response to the first signal and the second signal, and to output the image signal on which edge enhancement is performed by changing at least one of lightness and chroma in response to the determined lightness change and chroma change.

7. The liquid crystal display apparatus as claimed in claim 6, wherein said edge enhancement unit is configured to determine the lightness change and the chroma change to be made in the image signal such that a color difference falls within a predetermined range.

8. The liquid crystal display apparatus as claimed in claim 6, wherein said edge enhancement unit is configured to select, from a plurality of different combinations of a lightness change, a chroma change, and a hue change of the image signal within a range of a predetermined color difference, a combination that achieves a fastest response speed of a device for displaying the image signal, and is configured to perform the edge enhancement according to the selected combination.

9. The liquid crystal display apparatus as claimed in claim 6, further comprising:
a first color conversion unit configured to obtain the image signal by performing color conversion on a first image represented according to a predetermined color system and to supply the image signal to the supply node; and
a second color conversion unit coupled to an output of said edge enhancement unit to perform color conversion on the image signal on which the edge enhancement is performed, thereby to produce a second image represented according to said predetermined color system.

10. A liquid crystal display apparatus, comprising:
an edge detecting unit coupled to a supply node supplying an image signal, to produce at an output node thereof a first signal indicative of presence of an image edge in the image signal; and
an edge enhancement unit coupled to the supply node and the output node of said edge detecting unit to select, from a plurality of different combinations of a lightness change, a chroma change, and a hue change to be made in the image signal within a range of a predetermined color difference, a combination that achieves a fastest response speed of a device for displaying the image signal, and to output the image signal on which edge enhancement is performed by changing at least one of lightness, chroma, and hue according to the selected combination.
